(19) United States
(12) Patent Application Publication
(10) Pub. No.: US 2020/0076258 A1
(43) Pub. Date: Mar. 5, 2020

(54) Linear series of open jaw coil winding slots

(71) Applicant: Sten R. Gerfast, Mendota Heights, MN (US)

(72) Inventor: Sten R. Gerfast, Mendota Heights, MN (US)

(21) Appl. No.: 15/999,941

(22) Filed: Aug. 31, 2018

(51) Int. Cl. H02K 3/12; H02K 1/27; H02K 1/16; H02K 3/487; H02K 3/28

(52) U.S. Cl. CPC H02K 3/12; H02K 1/27; H02K 3/28; H02K 3/487; H02K 1/165

(57) ABSTRACT

Describes a new method for saving 65% of material in fabricating electro-magnetic coils. Made as a series of linear open jaw winding coil slots, in a sheet, with the individual coils connected together with bendable remnants. Several of these sheets can be combined to achieve the desired height, for the best thickness of the coil structure. The individually wound coils can be used as separate coils, in solenoids or in electro-magnetic relays, or combined as a stator, The “connection together” is accomplished by bendable remnants, which can be formed into a circle, and used as a stator. If used with a magnet rotor, the lack of winding slots minimizes “cogging”.

### SUMMARY OF THE INVENTION

This Application describes a new method of fabricating electro-magnetic coils, made as a linear series of open jaw coil winding slots in a sheet, but the individual coils are still connected together for ease of handling.

Several of these sheets can be combined to achieve the desired height, for the best thickness of the coil structure. The individually wound coils can be used as separate coils in solenoids or in electro-magnetic relays.

The “connection together” is accomplished by bendable remnants, which can be formed into a circle, and used as a stator.

The winding slots, are being closed together into non-existence, by this forming operation. The closing together of the slots, minimizes the magnetic “cogging” If the stator is used with a permanent magnet rotor. A steel casing surrounding the sheets enhances the magnetics in the remnant areas.

This assembly can be used as a stator in PSC motors, induction motors, brushless motors, brush-type motors and universal type motors.

This type of fabrication is saving 65% of sheet material, over a different type of construction, wherein the circle is fabricated by a punching of a complete circle in a sheet material.

Another advantage is, that the very open winding slots are suitable to wound more rapidly, easier and can have a larger amount of wires, because of the un-constrained openness of the winding slots. The larger amount of wires, increases the efficiency of any coil. In addition, another method that can be used when fabricating the coils, is to do a secondary double-forming, sometimes referred to “eyelet forming”. This is doubling “one sheet thickness” into “two”, and is also combining for the desired overall thickness.

This doubling saves one sheet of material, increasing additional savings, and could increase efficiency. Any holes in the double sheet can also be “formed into” the same thickness, with a punch.

### BACKGROUND

Both motors and generators generally have round stamped laminations punched out of flat rectangular sheets, wherein the sheet corners are a total wasted piece of material and are disposed as scrap. Another wasteful area is the center of the punched-out space for a rotor. Both motors and generators of the type, that often uses permanent magnets in the rotor, exhibits an un-desirable feature known as cogging. Efficiency of a motor or generator are generally dependent on the amount of copper windings that can be wound into the winding area in the stator.

The cogging, mentioned above, is caused by the permanent magnets on the rotor which are facing the stator poles. The stator poles faces are iron pole faces attracted by magnets. In order to do windings on the stator poles, they have to have winding slots. These windings slots are several discontinuities on the face of the iron stator. When the rotors permanent magnets pass over these discontinuities, magnetic attraction changes from high to low. This results in an instantaneous speed change, commonly known as cogging, which is un-desirable, and creates noise. Cogging is minimized by a flywheel or a heavy fan blade, or by electronic means.

Cogging problems occur both in the U.S. and in the rest of the world whenever permanent magnets are used.

### DESCRIPTION OF THE DRAWINGS

FIG. 1 is a series of open jaw winding slots fabricated in one operation. The number of slots can be varying from one (as an economical relay coil), to multiple slots (stator for motor/generator), and suitable for the ultimate use. Connected together for ease of use.

FIG. 2 is showing a composite view of the production steps of open jaw slots, during different stages of assembly. Many steps of assembly are shown.

FIG. 3 is showing eyelet forming or double forming of jaw winding slots and production from roll material.

FIG. 4 is showing in dash-lines where the eyelet forming takes place.

FIG. 5 is expanding FIG. 2 for more detailed explanations, such as insulation, winding and remnants, that are shown in details.

FIG. 6 is a punch which can be used to increase a hole thickness dimension to equal double forming dimension.

FIG. 7 is showing a prior art. It shows the wasted material when produced in the average and common fabrication method.

### DETAILED DESCRIPTION OF THE DRAWINGS

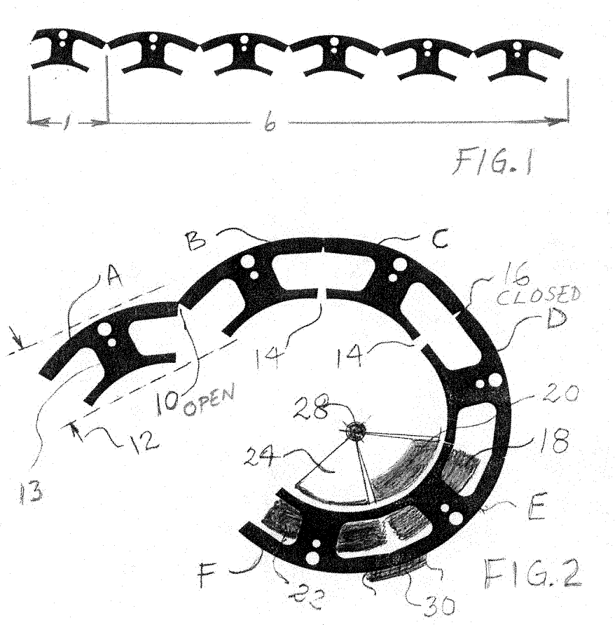

FIG. 1 is a series of open jaw winding slots fabricated in one operation. The number of slots can be varying from one (“1”) as an economical relay coil), to multiple slots “6” (stator for motor/generator) and suitable for the ultimate use. Connected together for ease of use.

FIG. 2 is showing a composite view of the production steps of open jaw slots 13, with remnants 10 during different stages of assembly, A to F. Many steps of assembly are shown Numeral 12 shows in A, is estimated width of the fabrication material. In B and C is shown partially closed winding slots 14, still with the possibility of winding. It is also showing how the remnant 16 is starting to close. In D the remnant 16 is closed and winding slot 14 is closed. In E winding 18 is done. A permanent rotor magnet 20 is shown opposite the winding 18. In F another winding 22 is done, opposite an induction rotor part 24. Both part 22 and 24 are shown rotating on a shaft 28. A section of an iron outside case part is shown at 30 to enhance the magnetics at the remnant.

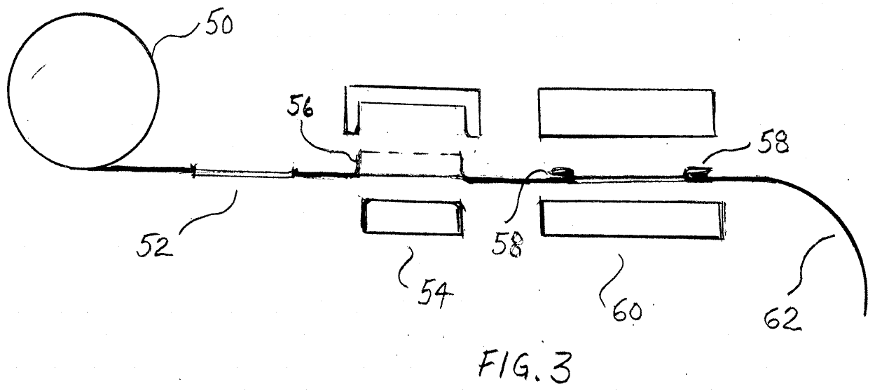

FIG. 3 is showing eyelet forming or double forming of open jaw winding slots and production from roll material 50. The blanking station 52, the extrusion station 56, and extrusion die 54, the double forming or eyelet forming 58. With a die 60, and further processing at 62.

FIG. 4 is showing in dash-lines where the eyelet forming takes place. The dash-lines 64 are indicating where the bending is occurring. The double formed part 66 is now increased to double thickness. Also indicated is a possible rivet hole 68 and a mounting hole 70. The rivet, and its rivet hole 68, can be eliminated, and a formed retention detail, that can take its place, commonly known as a “stich” is shown at 72, and also in a side view 74. The stich retains one open jaw slot 13 to the next open jaw slot 13, in succession until the desired height is reached.

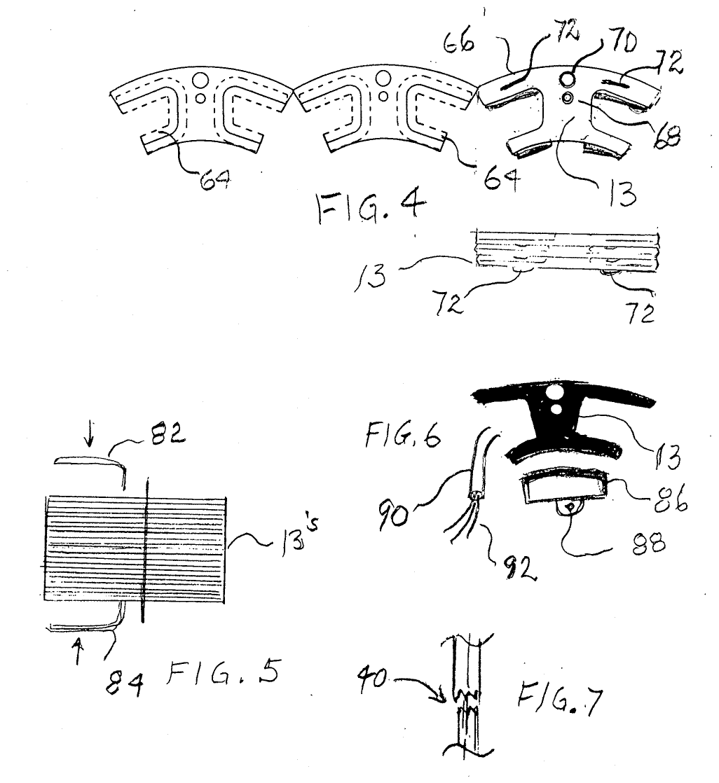

FIG. 5 is expanding on FIG. 2 for detailed explanations of a larger number of open jaws 13, being fitted with a tight fitting upper 82 insulation part and a tight fitting lower 84 insulation part, that can be fitted on 13. They are commonly known as slot-liners. In their place an epoxy coating (not shown) can be used.

Because of the very open jaw 13 a large winding needle can be used, with either a single thread or multiple threads in the needle. The remnants 10 are open during winding, and closes during forming into a circle.

FIG. 6 is how a number of 13's parts, one on another, are used as a relay coil, not yet wound, having a relay armature 86 and mounting 88. A winding needle 90 is shown at 92 with several wires.

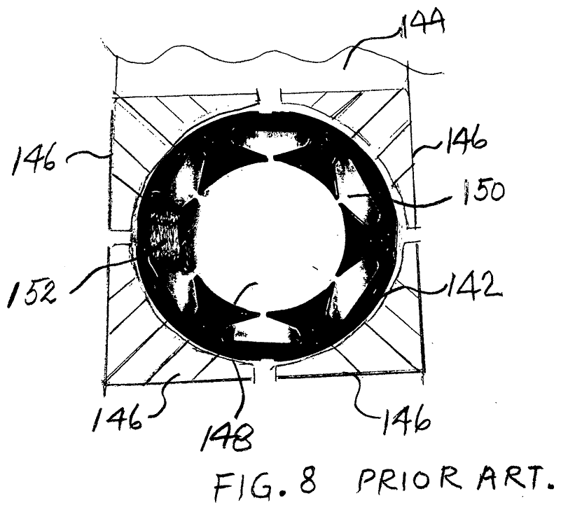

FIG. 7 is a punch 40 which can be used to increase a hole thickness dimension to equal double forming dimensions.

FIG. 8 is showing a prior art. It shows the wasted material when produced in any average and common fabrication method such as stamping a round part 142 out of a length of material 144 with four 146 wasted corners. Another waste is in the center 148.

The very small winding slots 150 are used with a 3D, articulated winding needle, a much more complicated winding system.

The 3D articulated needle is doing the winding in the very small winding slots, shown as several slots 150. One coils 152 is shown at a maximum diameter, because of the required space for the needle for the next winding. The present invention is doing the winding similar to a bobbin wind, a much simpler procedure, with a much better fill.

### A Series of Open Jaw Winding Slots With:

A summary of advantages:
Saving 65% of material.
More economical winding.
Wound more rapidly and easier.
Can have a larger amount of wires in the winding slots.
Higher amount of wires increases efficiency of any coil.
Connected together, for ease of handling.
Can be used as separate coils, or circle-formed for stator.
Can be used in solenoids or in electro-magnetic relays.
If formed in a circle, results in closing of the winding slots.
If used in stators, eliminating of slots, minimizes “cogging.
   when a permanent rotor is used.

1. A linear series of open jaw coil winding slots, comprising:
A linear series of open jaw coil winding slots, first made in its open jaw mode, wherein wires are wound as a second step, and then thirdly, jaws closed into a closed jaw mode, wherein the individual slots are connected with bendable remnants, the slots formed into a complete circle by bending at the remnants, creating a circle of electro-magnetic coils.

2. A series of open jaw coil winding slots according to claim 1, wherein the winding slots and remnant slots are closing during circle forming.

3. A series of open jaw coil winding slots according to claim 1 which by its design is saving 65% of the material, over a prior form of construction, wherein the circle is fabricated as a completed circle.

4. A series of open jaw winding slots according to claim 1 wherein the series can have any number of open jaw coil winding slots added together, one by one, into a stator.

5. A series of open jaw winding slots according to claim 1 wherein a number of open jaw coil winding slots are used as a relay coil, or electro-magnetic solenoid.

6. A series of open jaw winding slots according to claim 1 wherein the very open winding slots are suitable for winding:
more rapidly, easier and can have a larger amount of wires, because of the un-constrained openness of the winding slots.

7. A series of open jaw winding slots according to claim 6 wherein the very open winding slots are suitable for winding with one or several wires in the wiring needle.

8. A series of open jaw winding slots according to claim 6 wherein the larger amount of wires increases the efficiency of the coils.

9. A series of open jaw winding slots according to claim 1 wherein the winding slots has insulation, which is either an epoxy coating or a top and bottom slot liner.

10. A series of open jaw winding slots according to claim 1 wherein a varnish coat is applied after winding.

11. A series of open jaw winding slots according to claim 1 wherein after creating a circle, the electro-magnetic coils are fitted into an iron motor casing, which also add more magnetic iron around the remnants.

12. A series of open jaw winding slots according to claim 1 wherein the individual slots are double-formed, also known as “eyelet-forming”, making each slot double in thickness, creating “one equals two thicknesses stator part”, and any hole in the slots are also being double-increased by a punch.

13. A series of open jaw winding slots according to claim 12 wherein the double forming is doubling the thickness dimension of the total stator, thereby increasing the efficiency from 65% to a higher number.

14. A linear series of open jaw coil winding slots, comprising:
A linear series of open jaw coil winding slots, first made in its open jaw mode, wherein wires are wound as a second step, and then thirdly, jaws closed into a closed jaw mode, wherein the individual slots are connected with bendable remnants, the slots formed into a complete circle by bending at the remnants, creating a circle of electro-magnetic coils, wherein, after creating a circle, the winding slots have disappeared, thereby minimizing interaction between the circle and a permanent magnet rotor, if such a rotor is used, thereby also minimizing “cogging”.

15. A linear series of open jaw coil winding slots, comprising
A linear series of open jaw coil winding slots, first made in its open jaw mode, wherein wires are wound as a second step, and then thirdly, jaws closed into a closed jaw mode, wherein the individual slots are connected with bendable remnants, the slots formed into a complete circle by bending at the remnants, creating a circle of electro-magnetic coils, that are used as a stator, and used with different suitable rotors in:
PSC motors, induction motors, brushless motors, brush-type motors and universal type motors, making all these motors more economical.

16. A series of open jaw winding slots according to claim 4 wherein the individual series of winding slots are added together one by one, held together with rivets, or, as an alternative with formed details, also known as “stiches”.

17. A series of open jaw winding slots according to claim 1 fabricated with a stamping method, wire cutting or laser cutting.

18. A series of open jaw winding slots according to claim 1 fabricated continuously from roll material to wound stators.

19. A series of open jaw winding slots according to claim 1 wherein the winding is done with several wires, for faster winding.

20. A series of open jaw winding slots according to claim 1 wherein, the open jaw coil winding slots are linear for ease of handling.
